(19) United States
(12) Patent Application Publication
(10) Pub. No.: US 2026/0054392 A1
(43) Pub. Date: Feb. 26, 2026

(54) SEMANTIC ROBOT HAZARD AVOIDANCE WITH MULTI-MODAL PROMPTING

(71) Applicant: Boston Dynamics, Inc., Waltham, MA (US)

(72) Inventors: Michael James McDonald, Cambridge, MA (US); Jeffrey Chen Yu, Cambridge, MA (US)

(21) Appl. No.: 19/304,150

(22) Filed: Aug. 19, 2025

Related U.S. Application Data
(60) Provisional application No. 63/686,467, filed on Aug. 23, 2024.

(51) Int. Cl. B25J 9/16

(52) U.S. Cl. CPC B25J 9/1697; B25J 9/163; B25J 9/1666; B25J 9/1676

(57) ABSTRACT

Systems and methods for semantic robot hazard avoidance with multi-modal prompting are provided. In one aspect, a method includes receiving a user input indicative of one or more hazards in an environment of the robot and image data indicative of the one or more hazards in the environment. The method also includes generating one or more segments of the image data. Each of the one or more segments corresponds to at least one of the one or more hazards indicated by the user input. The method further includes identifying a semantic label for each of the one or more segments, generating a hazard map including a location of each of the one or more segments and the corresponding semantic label, and navigating the robot through the environment based at least in part on the hazard map.

### CROSS-REFERENCE TO RELATED APPLICATION(S)

This application claims the benefit of priority of U.S. Provisional Patent Application No. 63/686,467 , filed Aug. 23, 2024, the disclosure of which is hereby incorporated by reference in its entirety herein. Any and all applications for which a foreign or domestic priority claim is identified in the Application Data Sheet as filed with the present application are hereby incorporated by reference under 37 CFR 1.57.

### BACKGROUND

### Field

This disclosure relates to generally to robotics, and more particularly to detecting hazards for mobile robots.

### Description of the Related Technology

A robot is a reprogrammable and multifunctional manipulator designed to move material, parts, tools, or specialized devices through variable programmed motions for performance of tasks. Robots may be manipulators that are physically anchored (e.g., industrial robotic arms), mobile robots that move throughout an environment (e.g., legs, wheels, or traction based mechanisms), or some combination of a manipulator and a mobile robot. Robots are utilized in a variety of industries including, for example, manufacturing, transportation, hazardous environments, exploration, and healthcare. As such, the ability of robots to traverse environments with hazards provides additional benefits to such industries.

### SUMMARY OF CERTAIN INVENTIVE ASPECTS

An aspect of the present disclosure provides a method including receiving, by data processing hardware of a robot, a user input indicative of one or more hazards in an environment of the robot, receiving, from one or more sensors of the robot, image data indicative of the one or more hazards in the environment, generating, by the data processing hardware, one or more segments of the image data, each of the one or more segments corresponding to at least one of the one or more hazards indicated by the user input, identifying, by the data processing hardware, a semantic label for each of the one or more segments, generating, by the data processing hardware, a hazard map including a location of each of the one or more segments and the corresponding semantic label, and navigating, by the data processing hardware, the robot through the environment based at least in part on the hazard map.

In various embodiments, generating the one or more segments includes applying, by the data processing hardware, an open vocabulary object detection model to produce one or more bounding boxes corresponding to the at least one of the one or more hazards indicated by the user input, and converting, by the data processing hardware, the one or more bounding boxes to the one or more segments using a segmentation model.

In various embodiments, each of the open vocabulary object detection model and the segmentation model comprises a multi-modal machine learning model accepting two or more different modalities of input.

In various embodiments, the two or more different modalities include hazard affordances, text, images, and recorded trajectories of the robot through the environment.

In various embodiments, the image data includes a color image and a depth image.

In various embodiments, generating the one or more segments includes generating fused data by fusing a segmentation of the color image with corresponding depth information from the depth image.

In various embodiments, the method further includes generating the one or more segments based on the fused data, each of the one or more segments associated with a parameterized navigational affordance.

In various embodiments, generating the one or more segments includes providing, by the data processing hardware, the image data and the user input to an open vocabulary object detection model.

In various embodiments, generating the one or more segments includes generating a mask for portions of the color image not belonging to the at least one of the one or more hazards, the method further including masking the depth image using the mask, and generating the hazard map based on the masked depth image.

In various embodiments, the method further includes combining the one or more segments with corresponding depth information from the masked depth image, generating one or more geometric segments based on combining the one or more segments with the depth information, each of the one or more geometric segments associated with a parameterized navigational affordance, and generating the hazard map based on the one or more geometric segments and the parameterized navigational affordances.

In various embodiments, the method further includes determining, for each of the one or more geometric segments, the semantic label based on the user input, a confidence that the geometric segment is accurate, and the parameterized navigational affordance.

In various embodiments, the method further includes aggregating one or more segments observed from multiple perspectives as the robot navigates the environment and generating the hazard map further based on the aggregated one or more segments.

In various embodiments, the robot includes two or more legs.

In various embodiments, the robot is a quadruped.

In various embodiments, the robot is a biped.

Another aspect of the present disclosure provides a robot including a body, one or more sensors configured to generate image data indicative of one or more hazards in an environment of the robot, and a control system in communication with the body and the one or more sensors, the control system including data processing hardware and memory hardware in communication with the data processing hardware. The memory hardware stores instructions that when executed on the data processing hardware cause the data processing hardware to receive a user input indicative of the one or more hazards in the environment of the robot, receive the image data from the one or more sensors, generate one or more segments of the image data, each of the one or more segments corresponding to at least one of the one or more hazards indicated by the user input, identify a semantic label for each of the one or more segments, generate a hazard map including a location of each of the one or more segments and the corresponding semantic label, and navigate the robot through the environment based at least in part on the hazard map.

In various embodiments, to generate the one or more segments, the instructions further cause the data processing hardware to apply an open vocabulary object detection model to produce one or more bounding boxes corresponding to the at least one of the one or more hazards indicated by the user input, convert the one or more bounding boxes to the one or more segments using a segmentation model.

In various embodiments, each of the open vocabulary object detection model and the segmentation model includes a multi-modal machine learning model accepting two or more different modalities of input.

In various embodiments, the two or more different modalities include hazard affordances, text, images, and recorded trajectories of the robot through the environment.

In various embodiments, the image data includes a color image and a depth image.

In various embodiments, to generate the one or more segments, the instructions further cause the data processing hardware to generate fused data by fusing a segmentation of the color image with corresponding depth information from the depth image.

In various embodiments, the instructions further cause the data processing hardware to generate the one or more segments based on the fused data, each of the one or more segments associated with a parameterized navigational affordance.

In various embodiments, to generate the one or more segments, the instructions further cause the data processing hardware to provide the image data and the user input to an open vocabulary object detection model.

In various embodiments, to generate the one or more segments, the instructions further cause the data processing hardware to generate a mask for portions of the color image not belonging to the at least one of the one or more hazards, mask the depth image using the mask, and generate the hazard map further based on the masked depth image.

In various embodiments, the instructions further cause the data processing hardware to combine the one or more segments with corresponding depth information from the masked depth image, generate one or more geometric segments based on combining the one or more segments with the depth information, each of the one or more geometric segments associated with a parameterized navigational affordance, and generate the hazard map further based on the one or more geometric segments and the parameterized navigational affordances.

In various embodiments, the instructions further cause the data processing hardware to for each of the one or more geometric segments, determine the semantic label based on the user input, a confidence that the geometric segment is accurate, and the parameterized navigational affordance.

In various embodiments, the instructions further cause the data processing hardware to aggregate one or more segments observed from multiple perspectives as the robot navigates the environment and generate the hazard map further based on the aggregated one or more segments.

In various embodiments, the robot further includes two or more legs coupled to the body.

In various embodiments, the robot is a quadruped.

In various embodiments, the robot is a biped.

Another aspect of the present disclosure provides a non-transitory computer-readable medium having stored therein instructions that, when executed by data processing hardware of a robot, cause the data processing hardware to receive a user input indicative of one or more hazards in an environment of a robot, receive, from one or more sensors of the robot, image data indicative of the one or more hazards in the environment, generate one or more segments of the image data, each of the one or more segments corresponding to at least one of the one or more hazards indicated by the user input, identify a semantic label for each of the one or more segments, generate a hazard map including a location of each of the one or more segments and the corresponding semantic label, and navigate the robot through the environment based at least in part on the hazard map.

In various embodiments, to generate the one or more segments, the instructions further cause the data processing hardware to apply an open vocabulary object detection model to produce one or more bounding boxes corresponding to the at least one of the one or more hazards indicated by the user input, convert the one or more bounding boxes to the one or more segments using a segmentation model.

In various embodiments, each of the open vocabulary object detection model and the segmentation model includes a multi-modal machine learning model accepting two or more different modalities of input.

In various embodiments, the two or more different modalities include hazard affordances, text, images, and recorded trajectories of the robot through the environment.

In various embodiments, the image data includes a color image and a depth image.

In various embodiments, to generate the one or more segments, the instructions further cause the data processing hardware to generate fused data by fusing a segmentation of the color image with corresponding depth information from the depth image.

In various embodiments, the instructions further cause the data processing hardware to generate the one or more segments based on the fused data, each of the one or more segments associated with a parameterized navigational affordance.

In various embodiments, to generate the one or more segments, the instructions further cause the data processing hardware to provide the image data and the user input to an open vocabulary object detection model.

In various embodiments, to generate the one or more segments, the instructions further cause the data processing hardware to generate a mask for portions of the color image not belonging to the at least one of the one or more hazards, mask the depth image using the mask, and generate the hazard map further based on the masked depth image.

In various embodiments, the instructions further cause the data processing hardware to combine the one or more segments with corresponding depth information from the masked depth image, generate one or more geometric segments based on combining the one or more segments with the depth information, each of the one or more geometric segments associated with a parameterized navigational affordance, and generate the hazard map further based on the one or more geometric segments and the parameterized navigational affordances.

In various embodiments, the instructions further cause the data processing hardware to for each of the one or more geometric segments, determine the semantic label based on the user input, a confidence that the geometric segment is accurate, and the parameterized navigational affordance.

In various embodiments, the instructions further cause the data processing hardware to aggregate one or more segments observed from multiple perspectives as the robot navigates the environment and generate the hazard map further based on the aggregated one or more segments.

In various embodiments, the robot further includes two or more legs.

In various embodiments, the robot is a quadruped.

In various embodiments, the robot is a biped.

### BRIEF DESCRIPTION OF THE DRAWINGS

FIG. 1A is a perspective view of an example robot.

FIG. 1B is a schematic view of example systems of the robot of FIG. 1A.

FIG. 2 is a schematic view of an example hazard detection system of a robot (e.g., the robot of FIG. 1A).

FIG. 3 is an example of a technique that can be implemented by the hazard detection system to detect hazards and assign semantic labels to the detected hazards.

FIG. 4 is a diagram illustrating an example process of combining semantic and geometric information using the segmentation of image data.

FIG. 5 is a diagram illustrating an example process of hazard tracking and aggregation over time.

FIG. 6 is a diagram illustrating an example process of recording robot trajectories and using the recorded robot trajectories as user inputs for detecting hazards in the environment.

FIG. 7 illustrates an example method for generating a hazard map for navigating a robot.

FIG. 8 is a schematic view of an example computing device that may be used to implement the systems and methods described in this document.

### DETAILED DESCRIPTION

Hazards within an environment of a robot are one potential source of concern for the ability of the robot to safely and effectively navigate the environment. A hazard generally refers to an object or an attribute of the environment that blocks, hinders, or otherwise potentially negatively affects the robot's ability to traverse the space occupied by or nearby the object. Colliding, stepping on, or otherwise interacting with a hazard or even the act of avoiding a hazard (e.g., without specialty hazard avoidance systems) can detrimentally change the stability of a robot. For these reasons, certain robots attempt to identify and account for hazards and potential hazards within an environment for the robot.

Many techniques for identifying hazards involve identifying objects in the environment and determining whether the identified objects are safe for the robot to interact with or if the detected objects are hazards that should be avoided. However, there are a number of limitations to some techniques for identifying hazards.

For example, certain hazards may be difficult to identify using the depth sensors typically used for identifying hazards. For instance, a robot's sensors may return little-to-no information about the geometry of wires, railings, windows, and certain other structures. Another drawback may relate to the difficulty in determining whether an object is a hazard or is safe to interact with based on the object's geometry. This may be the case for groups of objects that share similar geometries, where some of the objects in the groups are stable and others are not (e.g., a cart may have a similar geometry to a stable platform).

Still another limitation to certain hazard identification techniques is properly interacting with or avoiding objects that a user may find undesirable for the robot to interact with. For example, a user may find it undesirable for the robot to walk under ladders even though it may generally be safe for the robot to do so. In this example, it may be difficult for the robot to properly interact with ladders using certain hazard identification techniques.

Furthermore, in some cases, a user may attempt to manually identify and/or define hazards. However, such a manual process may not be possible as a robot may navigate large environments and the environments may include different entities, obstacles, structures, and/or objects that may be hazardous. Further, the entities, obstacles, structures, and/or objects may be associated with numerous characteristics such that it may not be possible to manually identify all or a portion of the characteristics in an efficient manner. Such a manual process may cause issues and/or inefficiencies (e.g., inefficiencies in mission performance) as an inaccurate and/or incomplete model of the hazards may cause a robot to be unable to navigate (e.g., successfully) the hazards. Further, such a manual process may be resource, time intensive, and/or inefficient based on the amount of data associated with a robot.

Aspects of this disclosure relate to systems and techniques for addressing some or all of the above-described issues.

For example, in certain embodiments herein, a legged robot (for instance a quadruped or biped) is equipped with sensors that provide both color images and depth images of the surroundings. For instance, color image sensors can capture a 360-degree view of the surrounding environment on all sides of the robot's body while a LIDAR or other suitable depth sensor can provide additional depth information. The legged robot can include a navigation planner for autonomously walking through the environment and can operate with a collection of navigational maps (for instance, indicating walking exclusion regions as well as preferred walking regions) that can be automatically and continuously updated during operation.

To account for hazards, such a legged robot can be implemented with a multi-modal open vocabulary object detection model that receives color images and a list of prompts that can include text prompts and/or image prompts, and that outputs a collection of segments in the image for each region that corresponds to a given prompt. Such models can be implemented as neural networks or other learned multi-modal models that can accept both text and image prompts, which effectively serve as instructions of what the model should identify as hazards in the image. The prompts need not be limited to a pre-defined scope, but rather can be open vocabulary to allow a user to provide any desired text or image prompts to search for in the color image.

In certain implementations, the legged robot further includes a fusion component that combines the segmentation of the color image with corresponding depth information to determine geometric segments accompanied by a parametrization of navigational affordances to indicate a degree to which the legged robot should prefer or avoid walking near the region of the environment occupied by that segment. The fusion further component can output the geometric segments accompanied by their semantic label (e.g., the prompt that generated the segment), confidence that the segment is accurate, and/or numeric parameters to describe how the robot should prefer or avoid the segment when navigating. Thus, an effective hazard avoidance scheme for the robot can be achieved.

### Example Robot

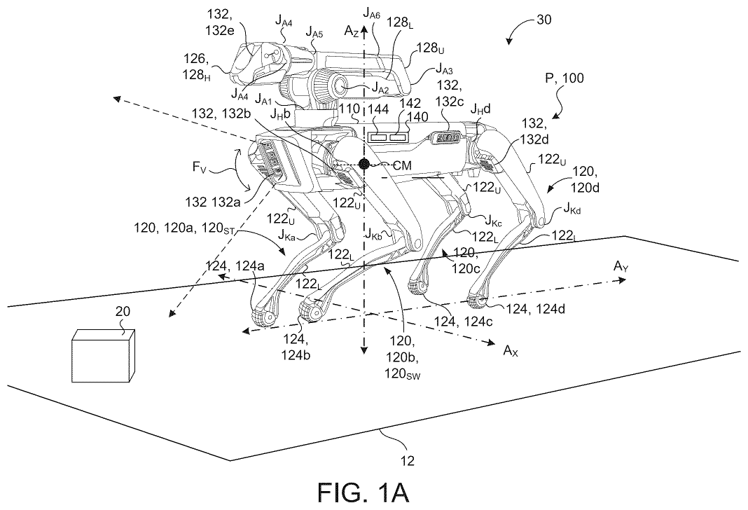

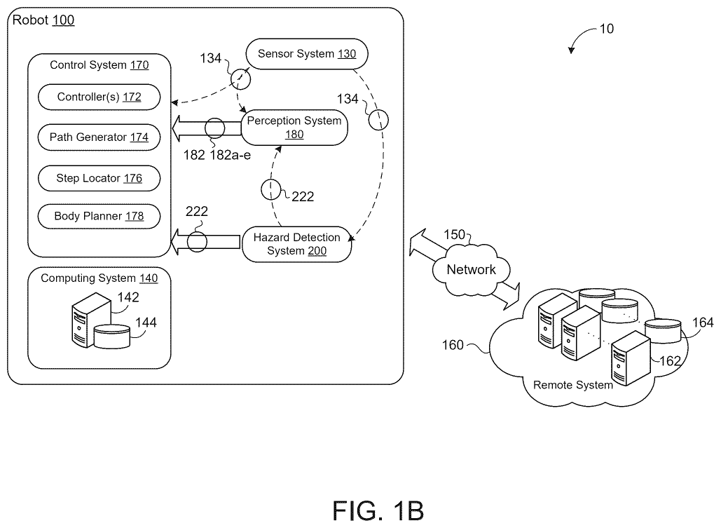

Referring to FIGS. 1A and 1B, the robot 100 includes a body 110 with one or more locomotion-based structures such as legs 120a-d coupled to the body 110 that enable the robot 100 to move about an environment that surrounds the robot 100. In some examples, each leg 120 is an articulable structure such that one or more joints J permit members 122 of the leg 120 to move. For instance, in the illustrated embodiment, each leg 120 includes a hip joint J_{H} coupling an upper member 122, 122_{U} of the leg 120 to the body 110 and a knee joint J_{K} coupling the upper member 122_{U} of the leg 120 to a lower member 122_{L} of the leg 120. Although FIG. 1A depicts a quadruped robot with four legs 120a-d, the robot 100 may include any number of legs or locomotive-based structures (e.g., a biped or humanoid robot with two legs, or other arrangements of one or more legs) that provide a means to traverse the terrain within the environment 30.

In order to traverse the terrain, each leg 120 has a distal end 124 that contacts a surface of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 corresponds to a foot of the robot 100. In some examples, though not shown, the distal end of the leg includes an ankle joint such that the distal end is articulable with respect to the lower member of the leg.

In the examples shown, the robot 100 includes an arm 126 that functions as a robotic manipulator. The arm 126 may be configured to move about multiple degrees of freedom in order to engage elements of the environment (e.g., objects within the environment). In some examples, the arm 126 includes one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128_{U}, and a hand member 128_{H} (also referred to as an end-effector). Here, the lower member 128_{L} may rotate or pivot about one or more arm joints J_{A} located adjacent to the body 110 (e.g., where the arm 126 connects to the body 110 of the robot 100). For example, FIG. 1A depicts the arm 126 able to rotate about a first arm joint J_{A1}, also referred to a yaw arm joint. With a yaw arm joint, the arm 126 is able to rotate in 360 degrees (or some portion thereof) axially about a vertical gravitational axis (e.g., shown as Az) of the robot 100. The lower member 128_{L} may pivot (e.g., while rotating) about a second arm joint J_{A2}. For instance, the second arm joint J_{A2} (shown adjacent the body 110 of the robot 100 just above the first arm joint J_{A1}) allows the arm 126 to pitch to a particular angle with respect to the body or a horizontal plane (e.g., raising or lowering one or more members 128 of the arm 126). The lower member 128_{L} is coupled to the upper member 128_{U} at a third arm joint J_{A3} and the upper member 128_{U} is coupled to the hand member 128_{H} at a fourth arm joint J_{A4}.

In some examples, such as FIG. 1A, the hand member 128_{H} (end-effector) is a mechanical gripper that includes one or more moveable jaws configured to perform different types of grasping of elements within the environment. In the example shown, the end-effector 128_{H} includes a fixed first jaw and a moveable second jaw that grasps objects by clamping the object between the jaws. The moveable jaw is configured to move relative to the fixed jaw in order to move between an open position for the gripper and a closed position for the gripper (e.g., closed around an object).

In some implementations, the arm 126 may include additional joints J_{A} such as the fifth arm joint J_{A5} and/or the sixth arm joint J_{A6}. The fifth joint J_{A5} may be located near the coupling of the upper member 128_{U} to the hand member 128_{H} and function to allow the hand member 128_{H} to twist or rotate relative to the lower member 128_{U}. In other words, the fifth arm joint J_{A4} may function as a twist joint similarly to the fourth arm joint J_{A4} or wrist joint of the arm 126 adjacent the hand member 128_{H}.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). In general, the CM will depend at any moment on the presence/absence and positions of the arm 126 and legs 120. The robot 100 further has a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 12 where distal ends 124 of the legs 120 of the robot 100 may generate traction to help the robot 100 move about the environment 30. Another anatomical plane of the robot 100 is the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis A_{X} and the z-direction axis A_{z}. In other words, the frontal plane bisects the robot 100 into a front portion and a rear portion. Here, the front portion of the robot 100 refers to the portion of the robot 100 with the front legs 120a-b while the rear portion of the robot 100 refers to the portion of the robot 100 with the hind legs 120c-d. Referring to FIG. 1A, when a leg 120 of the robot 100 is in a stance phase (e.g., the first leg 120a, 120_{ST}), the leg 120 is generally bent at the knee joint J_{K} (e.g., to support the load of the robot's body 110) such that the upper member 122_{U} of the leg 120 is at an angle less than 180 degrees with the lower member 122_{L} and the knee joint J_{K} extends further towards the rear portion of the robot 100 than the hip joint J _{H} that couples the upper member 122_{U} to the body 110 of the robot 100.

In order to maneuver about the environment or to perform tasks using the arm 126, the robot 100 includes a sensor system 130 with one or more sensors 132, 132a-n. For instance, FIG. 1A illustrates a first sensor 132, 132a mounted at a head of the robot 100, a second sensor 132, 132b mounted near the hip of the second leg 120b of the robot 100, a third sensor 132, 132c corresponding one of the sensors 132 mounted on a side of the body 110 of the robot 100, a fourth sensor 132, 132d mounted near the hip of the fourth leg 120d of the robot 100, and a fifth sensor 132, 132e mounted at or near the end-effector 128_{H} of the arm 126 of the robot 100. The sensors 132 may include vision/image sensors, inertial sensors (e.g., an inertial measurement unit (IMU)), force sensors, and/or kinematic sensors. Some examples of sensors 132 include a camera such as a stereo camera, a time-of-flight (TOF) sensor, a scanning light-detection and ranging (LIDAR) sensor, or a scanning laser-detection and ranging (LADAR) sensor. In some examples, the sensor 132 has a corresponding field(s) of view Fᵥ defining a sensing range or region corresponding to the sensor 132. For instance, FIG. 1A depicts a field of a view F_{V} for the first sensor 132, 132a of the robot 100. Each sensor 132 may be pivotable and/or rotatable such that the sensor 132 may, for example, change the field of view F_{V} about one or more axis (e.g., an x-axis, a y-axis, or a z-axis in relation to a ground plane). In some examples, multiple sensors 132 may be clustered together (e.g., similar to the first sensor 132a) to stitch a larger field of view F_{V} than any single sensor 132. With multiple sensors 132 placed about the robot 100, the sensor system 130 may have a 360 degree view or a nearly 360 degree view of the surroundings of the robot 100 about vertical and/or horizontal axes.

When surveying a field of view F_{V} with a sensor 132, the sensor system 130 (see, e.g., FIG. 1B) generates sensor data 134 (e.g., image data) corresponding to the field of view F_{V}. The sensor system 130 may generate the field of view Fᵥ with a sensor 132 mounted on or near the body 110 of the robot 100 (e.g., sensor(s) 132a, 132b, 132c). The sensor system may additionally and/or alternatively generate the field of view Fᵥ with a sensor 132 mounted at or near the end-effector 128_{H} of the arm 126 (e.g., sensor(s) 132e). The one or more sensors 132 may capture sensor data 134 that defines the three-dimensional point cloud for the area within the environment 30 about the robot 100. In some examples, the sensor data 134 is image data that corresponds to a three-dimensional volumetric point cloud generated by a three-dimensional volumetric image sensor 132. Additionally or alternatively, when the robot 100 is maneuvering about the environment 30, the sensor system 130 gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 30 about the robot 100.

In some implementations, the sensor system 130 includes sensor(s) 132 coupled to a joint J. Moreover, these sensors 132 may couple to a motor M that operates a joint J of the robot 100 (e.g., sensors 132, 132b-d). Here, these sensors 132 generate joint dynamics in the form of joint-based sensor data 134. Joint dynamics collected as joint-based sensor data 134 may include joint angles (e.g., an upper member 122_{U} relative to a lower member 122_{L} or hand member 126_{H} relative to another member of the arm 126 or robot 100), joint speed, joint angular velocity, joint angular acceleration, and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 or 128 coupled at a joint J) and systems of the robot 100 perform further processing to derive velocity and/or acceleration from the positional data. In other examples, a sensor 132 is configured to measure velocity and/or acceleration directly.

With reference to FIG. 1B, as the sensor system 130 gathers sensor data 134, a computing system 140 stores, processes, and/or communicates the sensor data 134 to various systems of the robot 100 (e.g., the computing system 140, the control system 170, the perception system 180, and/or the hazard detection system 200). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement-based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system 140 may allow processing to occur at an activity location (e.g., at motor that moves a joint of a leg 120) while a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remotely from the robot 100. For instance, the computing system 140 communicates via a network 150 with a remote system 160 (e.g., a remote server or a cloud-based environment). Much like the computing system 140, the remote system 160 includes remote computing resources, such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote resources 162, 164 as extensions of the computing resources 142, 144 such that resources of the computing system 140 may reside on resources of the remote system 160.

In some implementations, as shown in FIGS. 1A and 1B, the robot 100 includes a control system 170 and a perception system 180. The perception system 180 is configured to receive the sensor data 134 from the sensor system 130 and process the sensor data 134 to generate maps 182. With the maps 182 generated by the perception system 180, the perception system 180 may communicate the maps 182 to the control system 170 in order to perform controlled actions for the robot 100, such as moving the robot 100 about the environment 30. In some examples, by having the perception system 180 separate from, yet in communication with the control system 170, processing for the control system 170 may focus on controlling the robot 100 while the processing for the perception system 180 focuses on interpreting the sensor data 134 gathered by the sensor system 130. For instance, these systems 170, 180 execute their processing in parallel to ensure accurate, fluid movement of the robot 100 in the environment 30.

A given controller 172 of the control system 170 may control the robot 100 by controlling movement about one or more joints J of the robot 100. In some configurations, the given controller 172 is software with programming logic that controls at least one joint J or a motor M which operates, or is coupled to, a joint J. For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 122, 128 (e.g., actuation of the hand member 128_{H}) of the robot 100. By controlling one or more joints J, actuators or motors M, the controller 172 may coordinate movement for all different parts of the robot 100 (e.g., the body 110, one or more legs 120, the arm 126). For example, to perform some movements, a controller 172 may be configured to control movement of multiple parts of the robot 100 such as, for example, two legs 120a-b, four legs 120a-d, the arm 126, or any combination of legs 120 and/or arm 126 (e.g., two or four legs 120 combined with the arm 126). In some examples, a controller 172 is configured as an object-based controller that is set up to perform a particular behavior or set of behaviors for interacting with an interactable object.

In some examples, the control system 170 includes at least one controller 172, a path generator 174, a step locator 176, and a body planner 178. The control system 170 may be configured to communicate with at least one sensor system 130 and any other system of the robot 100 (e.g., the perception system 180 and/or the hazard detection system 200). The control system 170 performs operations and other functions using the computing system 140. The controller 172 is configured to control movement of the robot 100 to traverse about the environment 30 based on input or feedback from the systems of the robot 100 (e.g., the sensor system 130, the perception system 180, and/or the hazard detection system 200). This may include movement between poses and/or behaviors of the robot 100. For example, the controller 172 controls different footstep patterns, leg patterns, body movement patterns, or vision system-sensing patterns.

In some implementations, the control system 170 includes specialty controllers 172 that are dedicated to a particular control purpose. These specialty controllers 172 may include specialty controllers, such as but not limited to the illustrated path generator 174, step locator 176, and/or body planner 178. Referring to FIG. 1B, the path generator 174 is configured to determine horizontal motion for the robot 100. For instance, the horizontal motion refers to translation (i.e., movement in the X-Y plane) and/or yaw (i.e., rotation about the Z-direction axis AZ) of the robot 100. The path generator 174 functions by identifying obstacles within the environment 30 about the robot 100 (e.g., based on the perceptions maps 182 and/or information from the hazard detection system 200). The path generator 174 communicates the obstacles to the step locator 176 such that the step locator 176 may identify foot placements for legs 120 of the robot 100 (e.g., locations to place the distal ends 124 of the legs 120 of the robot 100). The step locator 176 generates the foot placements (e.g., locations where the robot 100 should step) using inputs from the perception system 180 (e.g., map(s) 182). The body planner 178, much like the step locator 176, receives inputs from the perception system 180 (e.g., map(s) 182). Generally speaking, the body planner 178 is configured to adjust dynamics of the body 110 of the robot 100 (e.g., rotation, such as pitch or yaw and/or height of COM) to successfully move about the environment 30.

The perception system 180 is a system of the robot 100 that helps the robot 100 to move more precisely in a terrain with various obstacles. The perception system 180 may include various elements including, for example, the hazard detection system 200 described herein. As the sensors 132 collect sensor data 134 for the space about the robot 100 (e.g., the robot's environment), the perception system 180 uses the sensor data 134 to form one or more perception maps 182 for the environment. Once the perception system 180 generates a perception map 182, the perception system 180 is also configured to add information to the perception map 182 (e.g., by projecting sensor data 134 on a preexisting map) and/or to remove information from the perception map 182.

In some examples, the one or more perceptions maps 182 generated by the perception system 180 are a ground height map 182, 182a, a no step map 182, 182b, a body obstacle map 182, 182c, a hazard map 182, 182d, and/or a cost map 182, 182e. The ground height map 182a refers to a perception map 182 generated by the perception system 180 based on spatial occupancy of an area (e.g., the environment 30) divided into three-dimensional volume units (e.g., voxels from a voxel map). In some implementations, the ground height map 182a functions such that, at each X-Y location within a grid of the map 182 (e.g., designated as a cell of the ground height map 182a), the ground height map 182a specifies a height. In other words, the ground height map 182a conveys that, at a particular X-Y location in a horizontal plane, the robot 100 should step at a certain height.

The robot 100 is configured to use one or more perception maps 182 (also referred to as navigational maps) to determine both where the robot 100 can or cannot walk (e.g., for both autonomous and manual navigation) as well as where the robot 100 prefers to walk (e.g., during autonomous navigation). The robot 100 can be configured to automatically and continuously update the perception maps 182 as the robot 100 navigates the environment.

The no step map 182b generally refers to a perception map 182 that defines regions where the robot 100 is not allowed to step in order to advise the robot 100 when the robot 100 may step at a particular horizontal location (e.g., location in the X-Y plane). In some examples, much like the body obstacle map 182c and the ground height map 182a, the no step map 182b is partitioned into a grid of cells where each cell represents a particular area in the environment 30 about the robot 100. For instance, each cell can be a three centimeter square. For ease of explanation, each cell exists within an X-Y plane within the environment 30. When the perception system 180 generates the no-step map 182b, the perception system 180 may generate a Boolean value map where the Boolean value map identifies no step regions and step regions. A no step region refers to a region of one or more cells where an obstacle exists while a step region refers to a region of one or more cells where an obstacle is not perceived to exist. The perception system 180 may further process the Boolean value map such that the no step map 182b includes a signed-distance field. Here, the signed-distance field for the no step map 182b includes a distance to a boundary of an obstacle (e.g., a distance to a boundary of the no step region) and a vector v (e.g., defining nearest direction to the boundary of the no step region) to the boundary of an obstacle.

The body obstacle map 182c generally determines whether the body 110 of the robot 100 may overlap a location in the X-Y plane with respect to the robot 100. In other words, the body obstacle map 182c identifies obstacles for the robot 100 to indicate whether the robot 100, by overlapping at a location in the environment 30, risks collision or potential damage with obstacles near or at the same location. As a map of obstacles for the body 110 of the robot 100, systems of the robot 100 (e.g., the control system 170) may use the body obstacle map 182c to identify boundaries adjacent, or nearest to, the robot 100 as well as to identify directions (e.g., an optimal direction) to move the robot 100 in order to avoid an obstacle. In some examples, much like other perception maps 182, the perception system 180 generates the body obstacle map 182c according to a grid of cells (e.g., a grid of the X-Y plane). Here, each cell within the body obstacle map 182c includes a distance from an obstacle and a vector pointing to the closest cell that is an obstacle (e.g., a boundary of the obstacle).

The cost map 182e generally provides a cost associated with a location in the X-Y plane with respect to the robot 100. In some embodiments, the cost map 182e can include X, Y, and THETA (e.g., robot 100 yaw angle) components. Thus, in some embodiments the cost map 182e can associate a cost with a yaw-angle of the robot 100 for a location in the X-Y plane. In some embodiments, the cost map 182e may be a map of continuous costs (e.g. non-boolean costs). The continuous costs may represent an extent to which the robot 100 “prefers to avoid” hazards in the environment. Thus, in some situations the robot 100 may be configured to overcome the cost associated with a particular location/yaw in order to prevent the robot 100 from getting blocked and/or stuck during navigation.

Referring further to FIG. 1B, the robot 100 also includes a hazard detection system 200. The hazard detection system 200 is a system of the robot 100 that functions to identify a hazard 20 (FIG. 1A) based on sensor data 134 from the sensor system 130 and to generate a hazard map 222 identifying the hazard 20. In some examples, the hazard detection system 200 provides feedback to the perception system 180, or may be considered a subsystem of the perception system 180. The perception system 180 may receive the hazard map 222 from the hazard detection system 200 as feedback and update or modify one or more maps 182 based on the hazard map 222.

In some instances, the robot 100 potentially encounters hazards as part of a mission that the robot 100 is instructed to perform by a user. For example, the mission can be associated with mission data indicating a navigation route of the robot 100 to navigate through an environment.

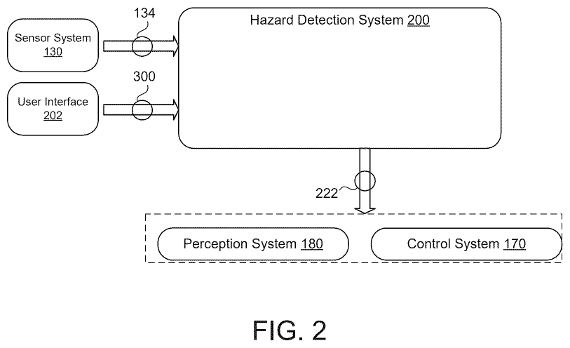

FIG. 2 is a high level block diagram illustrating a hazard detection system 200. Referring to FIG. 2, the hazard detection system 200 is configured to receive sensor data 134 from the sensor system 130 and user inputs 300 from a user interface 202. The hazard detection system 200 is configured to identify one or more hazards 20 within the sensor data 134 based on the user inputs 300 and generate a hazard map 222 including the one or more identified hazards 20 and associated semantic labels for the one or more hazards 20. The hazard detection system 200 can provide the hazard map 222 to the control system 170 and/or the perception system 180.

### Hazard Detection

To successfully navigate the environment, a robot 100 can include systems configured to identify hazards 20 in the environment such that the robot 100 can avoid or otherwise handle navigation around the hazards 20. Standard techniques for identifying and navigating around hazards 20 may present difficulties in certain scenarios. One example scenario is when the robot 100 is tasked with navigating around thin and other hard-to-see obstacles. Examples of hard-to-see objects may include: wires, railings, windows, and other structures for which depth sensors may return little-to-no information about the geometry of the objects.

Another example scenario involves the robot 100 navigating around obstacles with ambiguous geometry. Examples of obstacles with ambiguous geometry include: carts, cardboard boxes, and similar objects for which the structure of the object appears safe to walk on based on the sensor data 134 when the object is in fact not safe for the robot 100 to walk on. For example, it can be difficult to determine whether an object is a wheeled cart or a stable platform based on the geometry of the object alone. However, it can be dangerous for a robot 100 to walk on a cart which could roll out from under the robot 100, while it can be perfectly safe for the robot 100 to walk on a platform.

Yet another example scenario is when the robot 100 is navigating around objects and structures that the robot 100 can safely walk on, but a user may find undesirable. For example, the robot 100 may have the capability of stepping on autonomous mobile robots (AMRs) at certain facilities. From the perspective of the robot 100, AMRs may be stable and safe to walk over. AMRs may also appear similar to steps, platforms, or other safe-to-step on objects from a geometric perspective. However, AMRs are valuable machinery which a user may wish to avoid experiencing premature wear and tear, for example, due to the robot 100 walking over the AMR.

Furthermore, in some cases, a user may attempt to manually identify and/or define hazards. However, such a manual process may not be possible as the robot 100 may navigate large environments (for instance, as a part of a mission) and the environments may include different entities, obstacles, structures, and/or objects that may be hazardous. Further, the entities, obstacles, structures, and/or objects may be associated with numerous characteristics such that it may not be possible to manually identify all or a portion of the characteristics in an efficient manner. Such a manual process may cause issues and/or inefficiencies (e.g., inefficiencies in mission performance) as an inaccurate and/or incomplete model of the hazards may cause a robot to be unable to navigate (e.g., successfully) the hazards. Further, such a manual process may be resource, time intensive, and inefficient based on the amount of data associated with a robot.

Aspects of this disclosure address one or more of the above problems by using semantic information about the various hazards to classify the detected hazards. For example, for hard-to-see objects, in many cases it is easier to identify the objects in image data (e.g., in a color image). Semantic context can be obtained from the image data used to aid in identifying the hard-to-see objects. The semantic context can be combined with any available geometric information to infer the presence of the objects and the hazardous regions that the robot 100 should avoid.

As another example, for obstacles with ambiguous geometry, semantic information can add context to the geometry, enabling the robot 100 to determine whether the obstacle is safe to interact with. For example, if the robot 100 sees an obstacle with the corresponding semantic label “cart”, the robot 100 can determine that the obstacle is in fact hazardous to walk on.

Semantic knowledge can also be used to address scenarios where a user desires the robot not to step on an object that would otherwise be safe for the robot to step on. For example, one example object that a user may not desire the robot to step on is an AMR. By identifying a semantic label for the object (e.g., “AMR” in this example), the robot 100 can avoid stepping on or otherwise approaching the object too closely to conform with the user's desired behavior of the robot 100. In some aspects of this disclosure, the user's desired robot behavior can be communicated to the robot 100 by the user providing prompts to the robot 100 in the form of semantic or visual inputs. For example, users may have different preferences for how the robot 100 interacts with different objects, where one user may want the robot 100 to avoid a particular object while another user might want the robot 100 to walk over the same object. Thus, there is no “one-size-fits-all” model for the robot 100 to use in deciding which hazards to avoid.

Further aspects of this disclosure provide systems and techniques for enabling a robot operator to control the robot's 100 navigational affordances through the input of arbitrary text prompts, image prompts, and/or arbitrary trajectory recordings. This provides an elegant solution to the problems described above as it both provides a way to extract navigation-relevant information from color images (e.g., identifying properties that cannot be inferred from available depth/geometric information) and a method for easily allowing a user to configure what information should be extracted from the images (e.g., through the provision of natural language, example images, and/or direct control of the robot).

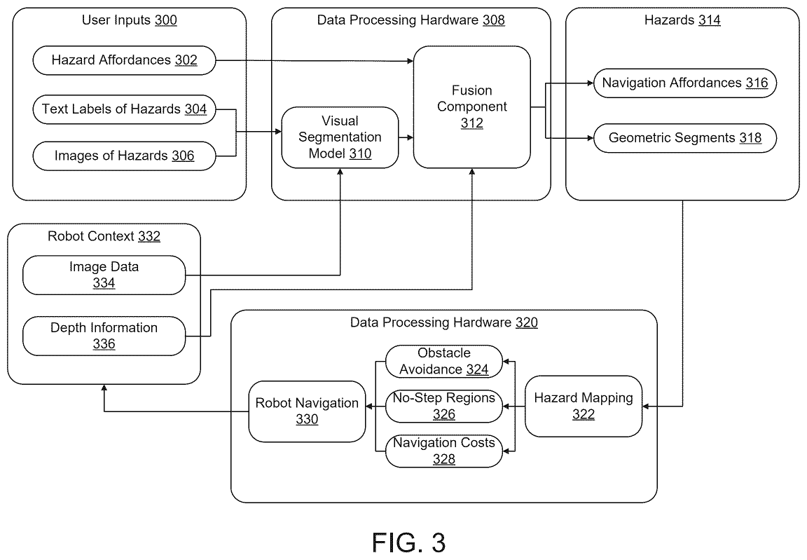

FIG. 3 is an example of a technique that can be implemented by the hazard detection system 200 to detect hazards and assign semantic labels to the detected hazards. With reference to FIG. 3, the hazard detection system 200 can receive one or more user inputs 300 which are processed by first data processing hardware 308 to generate one or more hazards 314. Second data processing hardware 320 processes the hazards 314 to generate a hazard map 222 which can be used for navigating the robot 100. Although the first data processing hardware 308 and the second data processing hardware 320 are illustrated as separate processing systems in FIG. 3, aspects of this disclosure are not limited thereto and a single processing hardware can be used to implement both blocks without departing from the scope of this disclosure.

As shown in FIG. 3, the user inputs 300 can include one or more hazard affordances 302, one or more hazard text labels 304 identifying hazards, and one or more hazard images 306 identifying hazards. In some embodiments, the user inputs 300 can also include other modalities (or modes) of input, such as recorded robot trajectories. As used herein, a hazard affordance 302 may generally refer to a metric indicative of how much the robot 100 should prefer or avoid walking near the hazard. Examples of hazard affordances 302 include: the robot should walk on “the ground”, should not walk over “the hole”, the robot should not walk on “the ice”, the robot should walk on “the stairs”, etc. Each of the one or more hazard affordances 302 may correspond to at least one of the hazard text labels 304 and/or at least one of the hazard images 306. Here, each of “the ground” and “the hole” may be represented by either a hazard text label 304 or a hazard image 306.

The hazard text labels 304 can include natural language that identifies one or more hazards that the robot 100 should avoid. One example text label is “the wires” indicating that there are one or more wires in the environment of the robot 100 which the robot 100 should avoid during navigation.

The hazard images 306 can include at least a portion of a hazard 20 which the robot 100 should avoid. For example, the hazard images 306 can include a picture of a cart, a hole, a wire, or any other type of hazard 20.

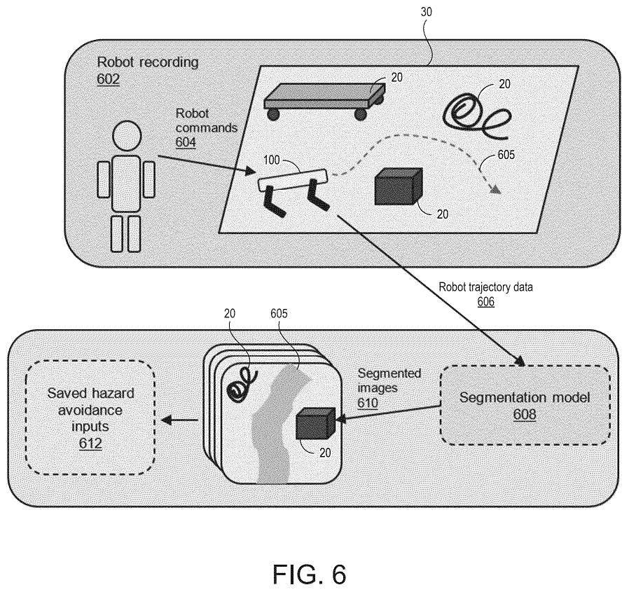

The user input 300 can also include other modalities (e.g., types) of user input 300. Another example mode of user input 300 includes previously recorded trajectories of the robot 100 navigating through the environment. In some embodiments, the robot 100 can be configured to identify hazards from the recorded trajectories for the robot 100 to avoid when navigating the environment in the future. Further examples of using previously recorded trajectories as user inputs 300 for identifying hazards 20 is provided in connection with FIG. 6.

The first data processing hardware 308 is configured to receive a user input indicative of one or more hazards in an environment of the robot (e.g., the user inputs 300) and image data indicative of the one or more hazards in the environment (e.g., the robot context 332). The robot context 332 can include image data 334 (e.g., robot camera images) which can be generated by one or more cameras included in the sensor 132 of the robot 100. The robot context 332 can also include depth information 336 (e.g., robot depth maps, point clouds, and/or depth images) which can be generated by one or more of the sensor system 130. For example, the depth information 336 can be generated by LIDAR sensors, stereo, TOF sensors, and/or LADAR sensors.

The first data processing hardware 308 is further configured to process the image data 334 to generate one or more segments of the image data 334. Each of the one or more segments corresponds to at least one of the one or more hazards indicated by the user input 300. For example, the first data processing hardware 308 is configured to implement a visual segmentation model 310 for segmenting the image data 334.

The visual segmentation model 310 is configured to receive the image data 334 as well as the hazard text labels 304 and the hazard images 306 as inputs. The visual segmentation model 310 is further configured to generate the one or more segments of the image data 334 based on the hazard text labels 304 and the hazard images 306. Depending on the embodiment, the image data 334 can be in color, grayscale, or other image formats. In some embodiments, the visual segmentation model 310 can generate the one or more segments of the image data 334 such that each of the one or more segments corresponds to one of the hazard text labels 304 and/or one of the hazard images 306. Each pixel within a segment may belong to a hazard indicated by the hazard text labels 304 and/or the hazard images 306. Accordingly, the visual segmentation model 310 can identify regions of the image data 334 that correspond to the hazard text labels 304 and/or the hazard images 306.

In some embodiments, the visual segmentation model 310 can include a multi-modal open vocabulary segmentation model. For example, the visual segmentation model 310 may be considered multi-modal when the visual segmentation model 310 is able to receive multiple different types of inputs. In the embodiment of FIG. 3, the multiple modalities can include the hazard text labels 304, the hazard images 306, and the image data 334. In some embodiments, the visual segmentation model 310 can also accept recorded robot trajectories as another mode of input. Other modalities of input can also be accepted by the visual segmentation model 310 without departing from aspects of this disclosure.

The visual segmentation model 310 may also be considered open vocabulary when the visual segmentation model 310 is configured to receive user inputs 300 (also referred to as “prompts”) that are not limited to a pre-defined scope. For example, the visual segmentation model 310 can receive virtually any hazard text labels 304 and/or hazard images 306 which are not limited to prompts encountered during training of the visual segmentation model 310. The visual segmentation model 310 can use the hazard text labels 304 and/or hazard images 306 to search the image data 334 and generate a segmentation of the image data 334. In contrast, closed vocabulary segmentation models are limited to only identifying objects/characteristics from a pre-defined list (e.g., closed set) of prompts. In contrast, open vocabulary segmentation models are configured to accept any prompt from the hazard text labels 304 and the hazard images 306.

In some embodiments, the visual segmentation model 310 comprises a neural network, and/or another learned multi-modal model configured to accept different types of inputs as prompts. The neural network, and/or another learned multi-modal model is trained to use the inputs (e.g., the hazard text labels 304 and/or hazard images 306) as the target objects and/or characteristics for the visual segmentation model 310 to identify within the image data 334.

In some embodiments, the visual segmentation model 310 can include one or more stages. For example, in one example the visual segmentation model 310 can have a first stage including an open vocabulary object detection model to produce bounding boxes corresponding to the user inputs 300 and a second stage including a second segmentation model configured to convert the bounding boxes to the one or more segments of the image data 334. Thus, the first data processing hardware 308 may apply the open vocabulary object detection model to produce one or more bounding boxes corresponding to the at least one of the one or more hazards indicated by the user input and convert the one or more bounding boxes to the one or more segments using the second segmentation model. Each of the open vocabulary object detection model and the second segmentation model can be implemented using a multi-modal machine learning model that accepts two or more different modalities of input. In other embodiments, the visual segmentation model 310 can include a single model configured to take the user inputs 300 and generate the one or more segments of the image data 334 without producing bounding boxes.

The first data processing hardware 308 is also configured to identify a semantic label for each of the one or more segments of the image data 334. The semantic label may be derived from the hazard text labels 304 and/or the hazard images 306. Thus, the first data processing hardware 308 can assign a semantic label to each of the one or more segments of the image data 334 based on the hazard text labels 304 and/or the hazard images 306 used to identify that segment.

In some embodiments, the fusion component 312 is configured to combine (e.g., fuse) the segmentation of the image data 334 with corresponding depth information 336. The fusion component 312 is configured to convert the combined segmentation of the image data 334 and corresponding depth information into geometric segments 318. In some embodiments, the fusion component 312 is configured to convert the combined segmentation of the image data 334 and corresponding depth information into geometric segments 318 using the hazard affordances 302 as an additional input. The fusion component 312 is also configured to generate a parametrization of navigational affordances 316 (also referred to as a parameterized navigational affordance) based on the combined segmentation of the image data 334 and corresponding depth information. The fusion component 312 can also use the hazard affordances 302 in generating the parametrization of navigational affordances 316. For example, since the hazard affordances 302 can identifying hazards, fusion component 312 can generate the navigational affordances 316 to avoid the hazards identified by the hazard affordances 302. The parametrization of navigational affordances 316 are indicative of how much the robot 100 should prefer or avoid walking near the region of the environment occupied by the corresponding geometric segments 318. By combining the depth information 336 with the segmentation of the image data 334, the fusion component 312 can determine the position of a surface of the segments in 3D space relative to the robot 100.

In some embodiments, the fusion component 312 can also, for each of geometric segments 318, determine a confidence that the corresponding geometric segment 318 is accurate. The fusion component 312 may also determine one or more numeric parameters that describe how the robot 100 should prefer or avoid each of the geometric segments 318 when navigating the environment. The fusion component 312 can generate the navigational affordances 316 based on the one or more numeric parameters such that the navigational affordances 316 describe how the robot 100 should prefer or avoid each of the geometric segments 318 when navigating the environment.

In some embodiments, the fusion component 312 is configured to mask the depth images from the depth information 336 using the segmentation of the image data 334 to generate the geometric segments 318. In some embodiments, the image data 334 can include color images obtained from the same camera as the depth images. Thus, the fusion component 312 can mask the depth images using the segmentation of the color images.

In some embodiments, the fusion component 312 can combine color images (which can be accompanied by intrinsic and extrinsic calibrations) with the depth information 336 obtained from the combined sensors 132 on the robot 100. For example, the depth information 336 can be combined from a plurality of sensor types, including LIDAR, stereo, TOF, and/or LADAR sensors.

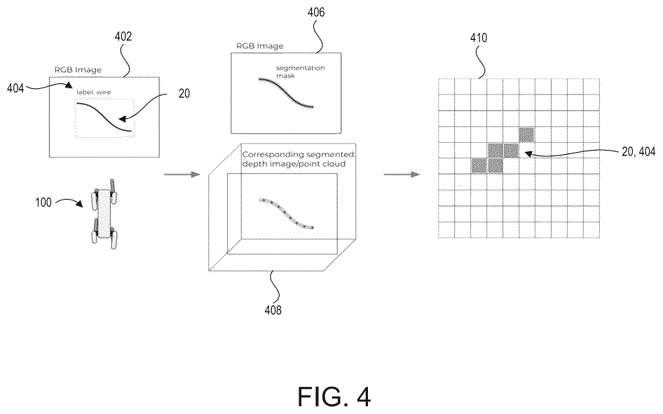

In some embodiments, each of the geometric segments 318 can include a point cloud of the corresponding segmentation of the image data 334. In other embodiments, each of the geometric segments 318 can include a masked depth image (e.g., a depth image where pixels of the image not belonging to the segment have been removed from the image). The use of the masked depth image in creating the geometric segments 318 is shown and discussed in connection with FIG. 4.

The second data processing hardware 320 receives the one or more hazards 314 from the first data processing hardware 308 and generates a hazard map that the robot 100 can use for navigating through the environment. In some embodiments, the hazard map can include a location of each of the geometric segments 318 and the corresponding semantic label.

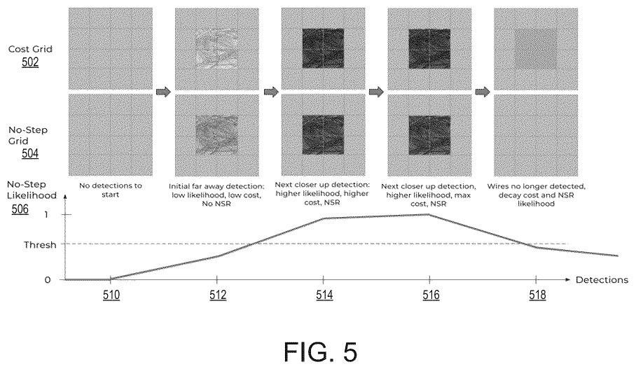

The second data processing hardware 320 can include a hazard mapping component 322 configured to generate the hazard map 222 based on the one or more hazards 314. The hazard mapping component 322 can aggregate the hazards 314 over time as the robot 100 moves through the environment. For example, the hazard mapping component 322 can update a likelihood of a detected hazard 314 being at a particular location as the robot 100 continues to detect the presence of the hazard 314. Further detail regarding the aggregation of the one or more hazards 314 over time is discussed in connection with FIG. 5. In some embodiments, the robot 100 can incorporate the hazard map 222 into one or more of the other maps 182 used for navigation.

The second data processing hardware 320 can generate obstacle avoidance regions 324, identify no-step regions 326, and determine navigation costs 328 based on the hazard map. For example, obstacle avoidance regions 324 may include regions for the body 110 of the robot 100 to avoid during navigation. The robot 100 can also avoid stepping in any no-step regions 326. The robot 100 may also determine navigation costs 328 based on the hazards and the associated navigation affordance included in the hazard map. In some embodiments, the obstacle avoidance regions 324 can be stored in the body obstacle map 182c, the no-step regions 326 can be stored in the no step map 182b, and the navigation costs 328 can be stored in the cost map 182e.

The second data processing hardware 320 can also perform robot navigation 330 based in part on each of the obstacle avoidance regions 324, the no-step regions 326, and the navigation costs 328, for example, using the body obstacle map 182c, the no step map 182b, and the cost map 182e. The robot 100 can obtain additional robot context 332 as the robot 100 navigates through the environment, which can then be fed back into the hazard mapping component 322 (e.g., via the visual segmentation model 310 and fusion component 312) to aggregate the hazards 314 over time.

FIG. 4 is a diagram illustrating an example process of combining semantic and geometric information using the segmentation of image data. In particular, FIG. 4 provides a visualization of the fusion process performed by the visual segmentation model 310, the fusion component 312 in certain embodiments, and the hazard mapping component 322.

As shown in FIG. 4, the robot 100 can receive a color image 402 (e.g., RGB image) from a camera included in the sensor system 130 of the robot 100. In some embodiments the color image 402 can include a hazard 20 and a semantic label 404 for the hazard 20. In some embodiments, the color image 402 and semantic label 404 can be generated by the visual segmentation model 310.

The robot 100 can generate a semantic mask 406 based on the color image 402. In some embodiments, the visual segmentation model 310 can generate the semantic mask 406. The robot can also receive depth information 408 (e.g., a depth image and/or point cloud) corresponding to the hazard. The robot 100 can also mask the depth information 408 using the semantic mask 406 to generate a hazard map 410. In some embodiments, the hazard map 410 can include a gravity-aligned 2D vision grid map, that includes the location of the hazard 20 and the corresponding semantic label 404. In some embodiments, the robot 100 can project the masked depth information into the gravity-aligned 2D vision grid map to determine the location of the hazard 20 within the hazard map 410.

FIG. 5 is a diagram illustrating an example process of hazard tracking and aggregation over time. As shown in FIG. 5, a cost grid 502, a no-step grid 504, and a no-step likelihood graph 506 as shown with respect to a plurality of detections taken at sequential points in time as the robot 100 navigates the environment. Time and the total number of detections are shown increasing from left to right. In some embodiments, the cost grid 502 and the no-step grid 504 can be different versions of the hazard map 410. For example, the cost grid 502 and the no-step grid 504 can be specialized versions of the gravity-aligned 2D vision grid map of the hazard map 410. In some embodiments, the cost grid 502 can be associated with the cost map 182e and the no-step grid 504 can be associated with the no step map 182b. The robot 100 can use the hazard tracking and aggregation process of FIG. 5 to update the cost map 182e and the no step map 182b based on the cost grid 502 and the no-step grid 504.

At a first point in time 510, when the robot 100 does not detect any hazards the cost grid 502 and the no-step grid 504 both show no hazards. The no-step likelihood 506 at the first point in time 510 is zero. At a second point in time 512, the robot 100 initially detects the presence of a hazard (e.g., wires) which are relatively far away from the robot 100. The confidence of the detection of the hazard as shown on the no-step likelihood graph 506 increases based on this initial detection, but the confidence level is still less than a threshold confidence level. Since the confidence level of the detected hazard is less than the threshold confidence level, the cost assigned to the hazard reflected in the cost grid 502 is relatively low and the no-step grid 504 does not yet mark the location of the hazard as a no-step region.

At the third point in time 514, the hazard is detected again at the same position as the robot 100 is closer to the hazard. Based on the additional detection of the hazard, the robot 100 increases the confidence of the detection of the hazard as shown on the no-step likelihood graph 506 above the threshold confidence level. In response to the confidence of the detection being above the threshold confidence level, the cost assigned to the hazard reflected in the cost grid 502 is relatively high and the no-step grid 504 marks the location of the hazard as a no-step region. The hazard is again detected at the fourth point in time 516, maintaining the confidence level, cost, and no-step region.

At the fifth point in time 518, the robot 100 moves away from the hazard, or the hazard has been removed from the environment, such that the hazard is no longer detected. Since the hazard is not detected by the robot 100, the robot 100 decreases the confidence of the detection of the hazard as shown on the no-step likelihood graph 506 below the threshold confidence level. In response to the confidence of the detection being below the threshold confidence level, the cost assigned to the hazard reflected in the cost grid 502 decays to a relatively low level and the no-step grid 504 marks the previous location of the hazard as no longer being a no-step region. Accordingly, the cost grid 502 and no-step grid 504 maps can be updated based on the detection and tracking of hazards over time to help the robot 100 execute the desired hazard avoidance behavior.

By tracking and aggregating the hazards over time, the robot 100 is able to take advantage of the robot's mobility to adjust the confidence of hazards within the hazard map over time. For example, the robot 100 can aggregate segments representing the hazards observed from multiple perspectives as the robot 100 navigates, building higher confidence and more reliable hazard maps than those obtained from a static view point.

FIG. 6 is a diagram illustrating an example process of recording robot trajectories and using the recorded robot trajectories as user inputs for detecting hazards in the environment. As shown in FIG. 6, the robot 100 can receive robot commands 604 for navigating an environment 30 with one or more hazards 20. The user can demonstrate surfaces and/or objects in the environment 30 which the robot 100 should walk on (e.g., hazard affordances 302) by providing the appropriate robot commands 604 to the robot 100.

The robot 100 can perform robot recording 602 to record robot trajectory data 606 as the robot 100 navigates the environment 30. The recorded robot trajectory data 606 can include the trajectory 605 of the robot 100 as the robot 100 navigated through the environment 30 as well as the sensor data 134 (e.g., image data 334 and/or depth information 336) generated by the sensor system 130 as the robot 100 navigated the environment 30.

The robot 100 can include a segmentation model 608 configured to receive the robot trajectory data 606 and generate a set of segmented images 610 based on the robot trajectory data 606. For example, the segmentation model 608 can segment each of the images from the image data 334 captured during the recording of the robot trajectory data 606. In some embodiments, the segmentation model 608 can also segment the depth information 336 (e.g., depth images) captured during the recording of the robot trajectory data 606. Each of the segmented images 610 can include one or more segments indicative of either a hazard 20 or the trajectory of the robot 100. In some embodiments, the set of segmented images 610 can be formatted in a sequence in the order in which the segmented images 610 were obtained.

In some embodiments, segmentation of the image data 334 and the depth information 336 by the segmentation model 608 may be similar to the process performed by the visual segmentation model 310 of FIG. 3 and as shown in the process of combining semantic and geometric information of FIG. 4. In some embodiments, the segmentation model 608 can include a multi-modal open vocabulary segmentation model configured to generate one or more segments of the robot trajectory data 606 indicative of a hazard and/or the trajectory 605. The robot 100 can save the set of segmented images 610 as saved hazard avoidance inputs 612 which can be used as an additional user input 300 provided to the first data processing hardware 308 of FIG. 3. Thus, in some embodiments the saved hazard avoidance inputs 612 can be used as an additional mode of input for the visual segmentation model 310 and/or the fusion component 312. In some embodiments, the saved hazard avoidance inputs 612 can be included in the set of hazard images 306 of hazards along with one or more corresponding hazard affordances 302 identifying the images from the saved hazard avoidance inputs 612 as examples of objects that the robot 100 should walk on.

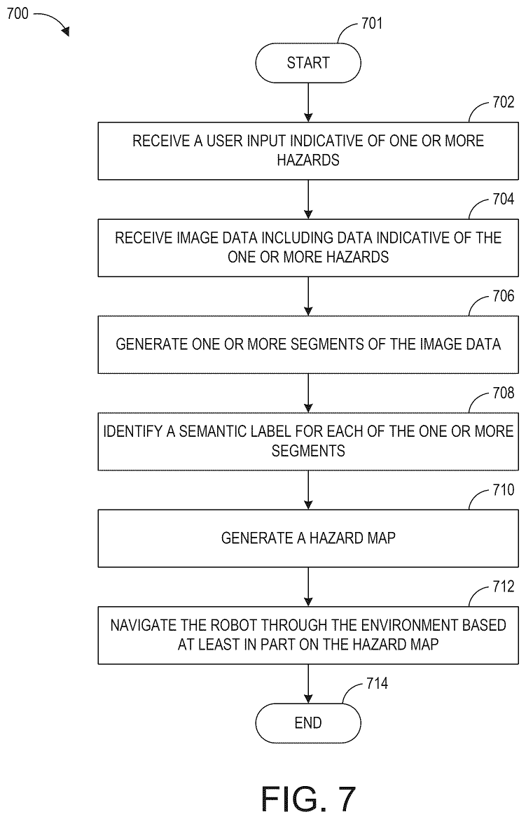

FIG. 7 illustrates an example method 700 for generating a hazard map for navigating a robot. One or more blocks of the method 700 may be implemented, for example, by data processing hardware of a robot (e.g., the robot 100 shown and described above in FIG. 1A or 1B), such as the data processing hardware 142 or the hazard detection system 200 of FIG. 1B or 2 or the first data processing hardware 308 and/or the second data processing hardware 320 of FIG. 3. The method 700 begins at block 701.

At block 702, the data processing hardware receives a user input indicative of one or more hazards in an environment of the robot. In some embodiments, the user input can include one or more hazard affordances 302, hazard text labels 304, and/or hazard images 306 as shown in FIG. 3.

At block 704, the data processing hardware receives image data (e.g., the image data 334 of FIG. 3) indicative of the one or more hazards in the environment from one or more sensors of the robot.

At block 706, the data processing hardware generates one or more segments of the image data. Each of the one or more segments corresponding to at least one of the one or more hazards indicated by the user input. In some embodiments, the data processing hardware can apply an open vocabulary object detection model to produce one or more bounding boxes corresponding to the at least one of the one or more hazards indicated by the user input and convert the one or more bounding boxes to the one or more segments using a segmentation model. In some embodiments, the data processing hardware can apply a multi-modal open vocabulary segmentation model to generate the one or more segments without generating bounding boxes.

At block 708, the data processing hardware identifies a semantic label for each of the one or more segments. For example, the data processing hardware can identify the semantic label for a given segment based on the user input corresponding to the segment.

At block 710, the data processing hardware generates a hazard map including a location of each of the one or more segments and the corresponding semantic label.

At block 712, the data processing hardware navigates the robot through the environment based at least in part on the hazard map. The method 700 ends at block 714.

Aspects of this disclosure provide a number of different advantages over previous hazard detection techniques. For example, the described technology provides techniques for combining arbitrary context from sensor data (including color images) with geometric information (e.g., obtained from depth information). This can provide the robot 100 with information that otherwise cannot be extracted from either image or depth information alone. The combination of the arbitrary context and geometric information enables the robot 100 to infer qualities for regions of the environment 30 have sparse and/or missing geometric information and also to infer qualities that are not solely geometric but are still relevant to the robot's 100 navigation.

Further aspects of this disclosure enable the robot 100 to accept intuitive user descriptions of navigational affordances, through text, images, and example trajectories. This allows for a robot operator to customize the robot's navigation through the use of user inputs that are more readily human understandable. Other systems for customizing navigation typically rely on providing robot-understandable information (e.g., geometric descriptions of obstacles, regions to avoid foot placement, etc.) that are not as intuitive to a human and do not convey semantic information. By accepting more user understandable inputs, the robot is able to focus on specific information during navigation, allowing the navigation/mapping components of the robot to filter out regions/structures that are not relevant to an operator's desired behavior. Other navigation systems have limited tools to infer this type of information and are not able to perform this type of filtering.

Advantageously, legged robots implementing the systems and methods described herein will step on fewer undesirable and/or dangerous structures and collide with fewer previously undetected obstacles. This significantly reduces the probability of the robot falling, tripping, and/or getting stuck and of damaging itself. This also allows the robot to autonomously navigate into a wider variety of regions with less human supervision. This further enables customers to deploy more robots per operator and allow the robots to perform tasks in sites they previously would have been blocked from.

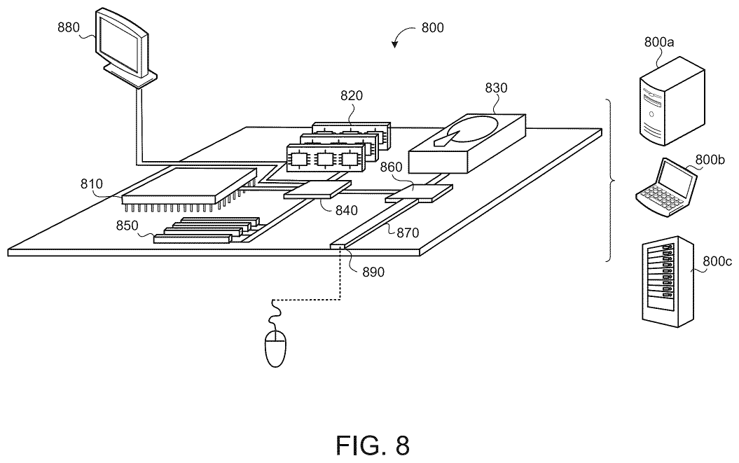

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low-speed interface/controller 860 connecting to a low-speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high-speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high-speed controller 840 manages bandwidth-intensive operations for the computing device 800, while the low-speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, by data processing hardware of a robot, a user input indicative of one or more hazards in an environment of the robot;
receiving, by the data processing hardware from one or more sensors of the robot, image data indicative of the one or more hazards in the environment;
generating, by the data processing hardware, one or more segments of the image data, each of the one or more segments corresponding to at least one of the one or more hazards indicated by the user input;
identifying, by the data processing hardware, a semantic label for each of the one or more segments;
generating, by the data processing hardware, a hazard map including a location of each of the one or more segments and the corresponding semantic label; and
navigating, by the data processing hardware, the robot through the environment based at least in part on the hazard map.

2. The method of claim 1, wherein generating the one or more segments comprises:
applying, by the data processing hardware, an open vocabulary object detection model to produce one or more bounding boxes corresponding to the at least one of the one or more hazards indicated by the user input; and
converting, by the data processing hardware, the one or more bounding boxes to the one or more segments using a segmentation model.

3. The method of claim 2, wherein each of the open vocabulary object detection model and the segmentation model comprises a multi-modal machine learning model accepting two or more different modalities of input.

4. The method of claim 3, wherein the two or more different modalities include hazard affordances, text, images, and recorded trajectories of the robot through the environment.

5. The method of claim 1, wherein the image data comprises a color image and a depth image.

6. The method of claim 5, wherein generating the one or more segments includes generating fused data by fusing a segmentation of the color image with corresponding depth information from the depth image.

7. The method of claim 6, further comprising generating the one or more segments based on the fused data, each of the one or more segments associated with a parameterized navigational affordance.

8. The method of claim 1, wherein generating the one or more segments comprises providing, by the data processing hardware, the image data and the user input to an open vocabulary object detection model.

9. The method of claim 8, wherein:
generating the one or more segments includes generating a mask for portions of the color image not belonging to the at least one of the one or more hazards,
the method further includes masking the depth image using the mask, and
generating the hazard map is further based on the masked depth image.

10. The method of claim 9, further comprising:
combining the one or more segments with corresponding depth information from the masked depth image; and
generating one or more geometric segments based on combining the one or more segments with the depth information, each of the one or more geometric segments associated with a parameterized navigational affordance,
wherein generating the hazard map is further based on the one or more geometric segments and the parameterized navigational affordances.

11. The method of claim 10, further comprising:
for each of the one or more geometric segments, determining: the semantic label based on the user input, a confidence that the geometric segment is accurate, and the parameterized navigational affordance.

12. The method of claim 1, further comprising:
aggregating one or more segments observed from multiple perspectives as the robot navigates the environment,
wherein generating the hazard map is further based on the aggregated one or more segments.

13. A robot comprising:
a body;
one or more sensors configured to generate image data indicative of one or more hazards in an environment of the robot; and
a control system in communication with the body and the one or more sensors, the control system comprising data processing hardware and memory hardware in communication with the data processing hardware, the memory hardware storing instructions that when executed on the data processing hardware cause the data processing hardware to:
receive a user input indicative of the one or more hazards in the environment of the robot;
receive the image data from the one or more sensors;
generate one or more segments of the image data, each of the one or more segments corresponding to at least one of the one or more hazards indicated by the user input;
identify a semantic label for each of the one or more segments;
generate a hazard map including a location of each of the one or more segments and the corresponding semantic label; and
navigate the robot through the environment based at least in part on the hazard map.

14. The robot of claim 13, wherein to generate the one or more segments, the instructions further cause the data processing hardware to:
apply an open vocabulary object detection model to produce one or more bounding boxes corresponding to the at least one of the one or more hazards indicated by the user input; and
convert the one or more bounding boxes to the one or more segments using a segmentation model.

15. The robot of claim 14, wherein each of the open vocabulary object detection model and the segmentation model comprises a multi-modal machine learning model accepting two or more different modalities of input.

16. The robot of claim 15, wherein the two or more different modalities include hazard affordances, text, images, and recorded trajectories of the robot through the environment.

17. The robot of claim 13, wherein the image data comprises a color image and a depth image, and wherein to generate the one or more segments, the instructions further cause the data processing hardware to generate fused data by fusing a segmentation of the color image with corresponding depth information from the depth image.

18. A non-transitory computer-readable medium having stored therein instructions that, when executed by data processing hardware of a robot, cause the data processing hardware to:
receive a user input indicative of one or more hazards in an environment of a robot;
receive, from one or more sensors of the robot, image data indicative of the one or more hazards in the environment;
generate one or more segments of the image data, each of the one or more segments corresponding to at least one of the one or more hazards indicated by the user input;
identify a semantic label for each of the one or more segments;
generate a hazard map including a location of each of the one or more segments and the corresponding semantic label; and
navigate the robot through the environment based at least in part on the hazard map.

19. The non-transitory computer-readable medium of claim 18, wherein to generate the one or more segments, the instructions further cause the data processing hardware to:
apply an open vocabulary object detection model to produce one or more bounding boxes corresponding to the at least one of the one or more hazards indicated by the user input; and
convert the one or more bounding boxes to the one or more segments using a segmentation model.

20. The non-transitory computer-readable medium of claim 19, wherein each of the open vocabulary object detection model and the segmentation model comprises a multi-modal machine learning model accepting two or more different modalities of input.
